(19) United States
(12) Patent Application Publication
(10) Pub. No.: US 2025/0273766 A1
(43) Pub. Date: Aug. 28, 2025

(54) THERMAL MANAGEMENT SYSTEM

(71) Applicant: SHELL USA, INC., Houston, TX (US)

(72) Inventor: Tianshi FANG, Houston, TX (US)

(21) Appl. No.: 18/857,287

(22) PCT Filed: May 16, 2023
(86) PCT No.: PCT/EP2023/063097

§ 371 Date: Oct. 16, 2024

(30) Foreign Application Priority Data
May 19, 2022 (US) 63343729

(51) Int. Cl. H01M 10/6569; C09K 5/06; H01M 10/613; H01M 10/625; H05K 7/20

(52) U.S. Cl. CPC H01M 10/6569; C09K 5/06; H01M 10/613; H01M 10/625; H05K 7/20381; H05K 7/208; H05K 7/20936

(57) ABSTRACT

The present invention provides a thermal management system comprising: a housing having an interior space; at least one heat-generating component disposed within the interior space; and a working fluid disposed within the interior space such that at least part of the heat-generating component is in direct contact with the working fluid; wherein the working fluid comprises base fluid and at least one phase change material selected from micro-encapsulated phase change materials, nano-encapsulated phase change materials, and mixtures thereof. The present invention also provides a method of thermal management of a heat-generating component comprising the steps of directly contacting at least part of the heat-generating component with a working fluid; and transferring the heat away from the heat-generating component using the working fluid wherein the working fluid comprises base fluid and at least one encapsulated phase change material selected from micro-encapsulated phase change materials, nano-encapsulated phase change materials, and mixtures thereof.

### FIELD OF THE INVENTION

This invention relates to a thermal management system and a method of thermal management for a heat-generating component.

### BACKGROUND OF THE INVENTION

Throughout a range of industries, new technologies are being sought in order to provide more energy efficient, lower CO₂ solutions. This invention relates to a number of possible efficiencies driving lower energy requirements and lower CO₂ emissions. Firstly, it relates to electric vehicle technology. Secondly, the invention is also applicable to the thermal management of IT equipment, such as servers. However, the invention described herein is not inherently limited by the technology to which it may be applied. The present invention is applicable to any heat-generating electric technology.

By 2040, it is expected that up to 50% of all new passenger car sales will be electric vehicles. This includes battery electric vehicles (BEV), hybrid electric vehicles (HEV), and plug-in hybrid vehicles (PHEV).

One of the core components in an electric vehicle is the battery. It requires effective thermal management. Current battery technology relies on lithium-ion batteries and it is likely that these will remain the dominant battery technology for at least the next 15 years. While slow charging at home or destination is likely to be the dominant way of charging, high-performance fast-charging (HPC) during a journey will be required by many customers who want to drive longer distances. To improve and shorten the charging process, it is required to increase voltage, current, or both at the same time. A higher current will also increase excess heat generated. The level of excess heat is very high and can reach 20 kWh or higher. Effective thermal management to control temperature, as well as the uniformity of temperature, within the cell pack is required to prevent battery cells from irreversible deterioration.

Within an electric vehicle, other components also require thermal management, especially cooling. Heat is generated by both the electric motor and the inverter in use. A method of thermal management that could be applied to each of these components and preferably a circuit incorporating all of these components (including the battery) would be most desirable.

Another type of electric vehicle is a fuel cell electric vehicle (FCEV). Fuel cell powered electrical systems also generate significant waste heat (approximately 50% of the energy is produced as waste heat) in use that needs to be removed during operation.

The thermal management of components provides challenges across other industries as well. The thermal management of IT components, especially servers, also provides many challenges. Air cooling of these components requires high energy usage and expensive cooling infrastructure. A simpler, more energy efficient system for the thermal management of these electronic components would be highly desirable.

Many cooling systems historically have used air passed over the source of heat in order to manage excess heat. However, due to the relatively small thermal conductivity, heat capacity, and density of air, the cooling effect can be limited. The infrastructure included in an air-cooling system can also be complex, expensive and involve the maintenance of many moving parts.

More advanced thermal management systems have been developed in which a conventional water/glycol mixture is used as a heat transfer fluid. A battery block, containing a large number of individual battery cells, may be effectively cooled with a water/glycol mixture. This is rapidly becoming the dominant thermal management technology in use in electric vehicles sold today as it is more efficient than air-cooling. US20090023056, US20100025006 and US2011021356, in the name of Tesla Motors Inc., describe pipe systems in which about 11% percent of the cell surface are in contact with pipes containing coolants. In these indirect thermal management systems, the heat needs to pass through the pipe material and then the heat is transferred to the glycol/water. Moreover, this configuration can limit the contact surface area through which heat can be transferred. These factors limit the overall effectiveness of this heat transfer design.

Under high-power charging (HPC) conditions, if these systems fail to control cell temperature and uniformity of temperature effectively, the battery management system (BMS) in the car limits the current to protect the battery. This can slow down the charging process very significantly and limits fast charging capability. Other systems may simply over-heat or be subject to safety shutdowns in high temperature conditions.

Direct liquid cooling involving novel thermal management systems, generally designed with heat-generating components in direct contact with a liquid coolant, can help control each component's temperature much more effectively, as the fluid is directly in contact with the component surface. In many direct cooling systems, the heat-generating components are fully or partially immersed in a cooling fluid. Thus, direct liquid cooling is also called immersion cooling or immersive cooling. However, not all direct cooling systems are immersive. For instance, in some applications, the cooling fluid is sprayed onto the heat-generating components. The term “direct cooling” is used herein, although this term is often used interchangeably with “immersion cooling” or “immersive cooling” in the industry. The term “direct cooling” as used herein encompasses immersive direct cooling systems and non-immersive direct cooling systems. Such a direct cooling system is described, for example, in US20170279172. To prevent short circuits, this requires a fluid with very good dielectric properties which means that the fluid must have low electrical conductivity. Suitable fluids also require low viscosity, to aid pumping, as well as high thermal conductivity and heat capacity. It has already been demonstrated that direct thermal management can help to increase power and energy density of batteries and also significantly enhance cell durability. While water/glycol based fluids have very high thermal conductivity and heat capacity, they are not dielectric. Thus, alternative working fluids need to be used in a direct thermal management system.

Developing improved methods and suitable working fluids for direct thermal management of electrical systems remains an on-going challenge. Such working fluids require excellent material compatibility, thermodynamic properties and low flammability. Cost and weight considerations need also to be taken into account for practical purposes. It is important that the fluids have low electrical conductivity levels, which can be maintained as the fluid ages, so as to prevent short circuits and/or damage to the heat-generating component. The avoidance of electrostatic charging of the working fluid during use, e.g. when pumping at high flow rates, is also desirable.

Phase change materials (PCMs) are very attractive for thermal control applications. When phase change is in progress, significant amount of heat can be taken away from the heat-generating components without remarkable temperature rise, thanks to the latent heats of PCMs. PCMs can be divided into liquid/vapour PCMs and solid/liquid PCMs.

Hydrofluorinated ethers are an example of liquid/vapour PCMs and are disclosed in WO2018/224908 where they are used for direct thermal management. Hydrofluorinated ethers reduce the flammability risk, but can result in challenges in material compatibility. An attractive feature of this class of fluid is the possibility of boiling. The boiling points of some hydrofluorinated ethers lie in the range of normal operating temperatures of lithium-ion batteries. By choosing a fluid with a certain boiling point, the fluid can boil during the cooling operation and its latent heat can be utilized for cooling and temperature control. An essential concern related to the application of liquid/vapour PCMs is the dramatic reductions of thermal conductivity and thermal capacity after boiling giving rise to poorer heat transfer performance. The possibility of pressurization is another substantial concern due to the liquid to vapour phase change.

As for solid/liquid PCMs, there have been applications in which heat generating components are surrounded by PCMs for cooling. A primary challenge is the maintenance of its shape after melting into liquid. To resolve this challenge, PCMs have been used together with matrix materials to form complex materials. The matrix materials will hold the shape of the PCMs after melting. A substantial concern related to such a system is the lack of cyclic flow of the cooling material. After all the available PCMs are melted, there is no mechanism of replenishment and no more effective cooling can be maintained. Solid/liquid PCMs have also been mixed with liquid cooling fluid. In this way, cyclic flow can be introduced while the advantage of PCMs can be employed. An example of this is disclosed in US2013/0004806 which discloses a microencapsulated phase change material used in conjunction with a cooling fluid as part of a thermal management system for an automotive battery pack assembly. However, this document is only concerned with indirect cooling of a battery.

Many common PCMs are organic materials, which can have lower densities than water. On the other hand, the cooling fluid for indirect cooling systems are usually water/glycol based. The differences in densities can make it challenging to uniformly suspend the microencapsulated PCM's in the base fluid. They may float on the fluid surface.

Fischer-Tropsch derived base fluids have been shown to be promising for direct cooling. European patent application no. 20166789.6 discloses a thermal management system wherein a heat-generating component such as a battery is directly cooled via a working fluid comprising a Fischer-Tropsch derived base fluid. The thermal conductivity and heat capacity of Fischer-Tropsch derived base fluids are generally higher than those of hydrofluorinated ethers but are still much lower than those of water/glycol based fluids. Meanwhile, Fischer-Tropsch derived base fluids do not boil during normal operation. No latent heat can be utilized for the thermal control.

It would be desirable to develop an improved thermal management system which overcomes the limitations of known thermal management systems, as mentioned above. It would also be desirable to develop a thermal management system which makes use of direct cooling, but in which the cooling fluid provides more effective cooling to the heat-generating component it is intended to be cooling. In particular, it would be desirable to develop a thermal management system which makes use of direct cooling, but in which the heat capacity of the cooling fluid is increased.

### BRIEF DESCRIPTION OF THE DRAWINGS

FIG. 1 illustrates a simplified circuit for a thermal management system of the present invention.

FIG. 2 is a schematic diagram of a thermal analysis of a directly cooled battery module, which is one embodiment of the thermal management system of the present invention.

FIG. 3 is a schematic diagram of the equilibrium location of the encapsulated phase change material (PCM) in a fluid flow through the gap between battery cells or between battery cells and the module housing. It is useful to the thermal analysis illustrated in FIG. 2.

FIG. 4 shows the generic temperature distributions on battery cell surfaces, as are derived from the thermal analysis. The parameters are denoted with symbols. No parameter values have been integrated in the generic results.

FIG. 5 shows the temperature distributions in a case study with typical materials and typical battery cells.

FIG. 6 shows the results of testing of exemplary embodiments.

### SUMMARY OF THE INVENTION

The present invention provides a thermal management system comprising:
a housing having an interior space;
at least one heat-generating component disposed within the interior space;
and
a working fluid disposed within the interior space such that at least part of the heat-generating component is in direct contact with the working fluid;
   wherein the working fluid comprises base fluid and at least one phase change material selected from micro-encapsulated phase change materials, nano-encapsulated phase change materials, and mixtures thereof.

The present invention also provides a method of thermal management of a heat-generating component comprising the steps of directly contacting at least part of the heat-generating component with a working fluid; and transferring the heat away from the heat-generating component using the working fluid wherein the working fluid comprises a base fluid and an encapsulated phase change material selected from a micro-encapsulated phase change material, a nano-encapsulated phase change material, and mixtures thereof.

In a preferred embodiment, the base fluid is a Fischer-Tropsch derived base fluid.

It has been found that the present invention provides an improved direct thermal management system which allows the heat-generating component, such as a battery, to be more effectively maintained at its optimal operating temperature. Hence, the thermal management system of the present invention can effectively enhance the efficiency of a battery and promote battery life.

In particular it has been found that the thermal properties, particularly the heat capacity, of a direct cooling fluid, such as a direct cooling fluid which comprises a Fischer-Tropsch derived fluid, are enhanced with the addition of said phase change materials (PCMs).

Further it has been found that the use of encapsulated phase change materials in the thermal management system of the present invention can defer the battery temperature rise and thus better prevent overheating.

Moreover, it has been found that the use of encapsulated phase change materials in the thermal management system of the present invention can maintain a greater portion of the battery cells at an optimal working temperature.

### DETAILED DESCRIPTION OF THE INVENTION

The present invention has been found to substantially enhance the effectiveness of direct thermal management systems, wherein a heat-generating component is in direct contact with a working fluid. This has been achieved through the introduction of encapsulated phase change materials in the working fluid.

The heat-generating component is preferably an electrical element. Typical electrical elements that may benefit from the system and method described herein include computer servers, batteries, inverters, electric motors and fuel cells, or any combination of these.

One or more heat-generating components may be cooled within the thermal management system of the invention.

The thermal management system of the invention comprises a housing having an interior space; a heat-generating component disposed within the interior space; and a working fluid disposed within the interior space such that at least part of the heat-generating component is in direct contact with the working fluid. As used herein, the phrase ‘direct contact’ means that the heat-generating component is partially immersed, and up to fully immersed, in the working fluid, or that a part of the heat-generating component or the whole heat-generating component is brought into contact with the working fluid via a spray or jet. In a preferred embodiment herein, the heat generating component is partially immersed, and up to fully immersed in the working fluid. In a preferred embodiment, at least 20%, more preferably at least 60%, even more preferably at least 90% of the surface area of the heat-generating component is in direct contact with the working fluid. In a particularly preferred embodiment, 100% of the surface-area of the heat-generating component is in direct contact with the working fluid.

The thermal management system is preferably constructed such that, when necessary and as controlled by a control system, a cyclical flow of working fluid can be maintained across the one or more heat-generating components, on to a heat exchanger and then back to the heat-generating component.

Said heat exchanger may be disposed within or external to the housing.

The thermal management system may comprise a liquid circuit with a pump and a heat exchanger. In this embodiment, the pump operates to move the working fluid from the heat-generating component to and from the heat exchanger. The pump is preferably controlled by a control system so that it produces a proper flow rate of the working fluid based on the instantaneous operating conditions.

Heat is transferred from the heat-generating component to the working fluid. The working fluid may then be pumped away from the heat-generating component to a heat exchanger. Heat may then be transferred from the working fluid via the heat exchanger. The working fluid may then be returned to the heat-generating component.

As well as functioning to remove heat from the heat-generating component disposed therein, the thermal management system may also be suitable to provide heat to the heat-generating component at certain times during the functioning of said component, e.g. at start-up or during running in cold environments. In this embodiment of the invention a source of heating will be included in the thermal management system. Such a source of heat may comprise an internal heat source or an external heat source. A control mechanism will also be included in the thermal management system to allow switching between cooling and heating embodiments of the system.

A suitable internal heat source may involve a battery with a load to form a heat-generating circuit. Suitable external heat sources include heat pumps, phase change materials capable of releasing heat upon the phase change, electric heaters and heaters burning ethanol, bioethanol or other fuels.

The working fluid comprises a base fluid and at least one encapsulated phase change material (PCM).

The encapsulated phase change material is made up of very small bi-component particles or capsules that include an inner core material of high latent heat tailored to phase change within a temperature range typically encountered in the heat-generating component(s), encased within an outer shell or capsule, typically made from a polymer or related material.

In order to retain the fluidity of the base fluid, e.g. Fischer-Tropsch derived base fluid, and prevent agglomeration of the PCMs, it has been found useful to encapsulate the PCMs at micrometre and/or nanometre scale and disperse in the base fluid. Hence, the encapsulated phase change material for use herein is selected from a micro-encapsulated phase change material, a nano-encapsulated phase change material, and mixtures thereof. For clarity, the encapsulated phase material can include mixtures of two or more micro-encapsulated phase change materials and mixtures of two or more nano-encapsulated phase change materials as well as mixtures of one or more micro-encapsulated phase change materials with one or more nano-encapsulated phase changes materials.

The average particle diameter of the phase change material capsules for use herein is typically in the range from 5 nm to 200 μm, more preferably from 10 nm to 50 μm. The particle diameter of the encapsulated phase change material is measured using well known analytical techniques familiar to those skilled in the art, such as SEM and TEM.

The term ‘micro-encapsulation’ as used herein typically means that the particle diameter is in the range from 1 μm to 1 mm, preferably from 1 μm to 200 μm. The term ‘nano-encapsulation’ means that the particle diameter is smaller than 1 μm.

Macro-encapsulated phase change materials (i.e. typically a particle size of greater than 1 mm) are not suitable for use herein.

Preferably, the actual melting point of the phase change material is selected based on the optimal operating temperature of the specific heat-generating component. As an example, for cooling of lithium-ion batteries, the core of the phase change material should have a melting point in the range from 20° C. to 60° C., preferably from 30° C. to 55° C.

The melting points of some phase change materials in the list below are higher than 60° C., but they may still be used together with other phase change materials to form a eutectic mixture of phase change materials, provided the eutectic mixture has a melting point of no higher than 60° C.

By careful selection of certain materials for the encapsulation, the desirable dielectric properties of the bulk fluid can be retained. Moreover, by matching the melting point of the PCM with the optimal operating temperature of the batteries, the batteries can be more effectively maintained at their optimal operating temperature.

While in theory both solid-liquid phase change materials and liquid-vapour phase change materials can be used to form the inner core, solid-liquid phase change materials are preferred herein because of their small volume variation. While not wishing to be limited by theory, it is believed that by adopting solid-liquid PCMs, the pressurization and the reduction in thermal properties associated with liquid-vapor phase change can be avoided.

The inner core preferably comprises one or more materials selected from paraffinic waxes, n-alkanes, fatty acids, fatty alcohols, C4-C14 alkyl alcohols, fatty acid esters, polyglycols, chlorinated paraffin, inorganic salts, salt hydrates, sugar alcohols, carbohydrates and polyols, and eutectic mixtures thereof made from one or more of the aforementioned materials.

Suitable n-alkanes for use herein include those having 17 to 27 carbon atoms, including heptadecane, octadecane, nonadecane, eicosane, heneicosane, docosane, tricosane, tetracosane, pentacosane, hexacosane, heptacosane and mixtures thereof.

n-alkanes having higher carbon numbers may also be used in eutectic mixtures with other phase change materials.

Suitable fatty acids for use herein include capric acid, lauric acid, myristic acid, palmitic acid, stearic acid, arachidic acid, and mixtures thereof.

Suitable fatty alcohols for use herein include 1-dodecanol, 1-tridecanol, 1-tetradecanol, 1-pentadecanol, 1-hexadecanol, 1-heptadecanol, 1-octadecanol, and mixtures thereof.

Suitable C4-C14 alkyl alcohols include 2-methyl-2-propanol, 2,2-dimethyl-1-propanol, cyclohexanol, diphenylmethanol, and mixtures thereof.

Suitable fatty acid esters include butyl stearate, propyl palmitate, vinyl stearate, methyl stearate, and mixtures thereof.

Suitable polyglycols include polyalkylene glycols such as polyethylene glycols.

Suitable inorganic salts and salt hydrates include LiNO₃·3H₂O, Na₂SO₄·10H₂O, Na₂CO₃·10H₂O, NACH₃COO·3H₂O, Na₂HPO₄. 12H₂O, Na₂HPO₄·7H₂O, Na₂S₂O₃·5H₂O, Na₂CrO₄·10H₂O, NaOH·H₂O, KF·4H₂O, KF·2H₂O, K(CH₃COO)·1.5H₂O, K₃PO₄·7H₂O, CaCl₂·6H₂O, CaBr₂·6H₂O, Ca(NO₃)₂·4H₂O, Zn(NO₃)₂·6H₂O, Zn(NO₃)₂·4H₂O, Zn(NO₃)₂·2H₂O, Cd(NO₃)₂·4H₂O, Mn(NO₃)₂·6H₂O, Fe(NO₃)₂·6H₂O, Ba(OH)₂·8H₂O, Na₂B₄O₇·10H₂O, Na₃PO₄·12H₂O, Na₂P₂O₇·10H₂O, MgCl₂·6H₂O, Mg(NO₃)₂·6H₂O, Ba(OH)₂·8H₂O, (NH₄)Al(SO₄)₂·12H₂O, and mixtures thereof.

Suitable sugar alcohols include, for example, erythritol, mannitol, galactitol, and mixtures thereof.

A suitable carbohydrate, for example, is ribose.

A suitable polyol, for example, is pentaerythritol.

Preferably the inner core comprises an n-alkane having from 17 to 27 carbon atoms. In one embodiment, the inner core is eicosane. Eicosane is a paraffin-based mixture of alkanes that exhibit a high latent heat of fusion (for example about 240 KJ/kg). Moreover, the melting point (about 37° C.) of eicosane makes it ideal for electric vehicle and related automotive applications, where a typical battery cell can encounter accelerated degradation and/or have elevated risk of thermal runaway when the temperature exceeds 40° C. Such paraffin-based PCMs are an excellent electrical insulator, with a high electrical resistivity of between 10¹³ and 10¹⁷ ohm meter, thus promoting safe, reliable electrical operation.

The outer shell preferably comprises one or more materials selected from polymers, resins, inorganic oxides, multi-walled carbon nanotubes, nanocelluloses and mixtures thereof.

Suitable polymers for use in the outer shell include, for example, polymethyl methacrylate (PMMA), polystyrene, polyurea, polyurethane, polyethylene, polysiloxane, gelatin, and their copolymers, and mixtures thereof. The polymers may be cross-linked or not cross-linked.

Suitable resins for use in the outer shell include, for example, melamine-formaldehyde resins, urea-formaldehyde resins, and epoxy resins, and mixtures thereof. The resins may be cross-linked or not cross-linked.

Suitable inorganic oxides for use in the outer shell include, for example, SiO₂, boehmite, CaCO₃, TiO₂, ZrO₂, and mixtures thereof.

Preferably, the outer shell is a polymeric material.

Commercially available examples of encapsulated phase change materials suitable for use herein include those available from Microtek under the tradenames, Nextek®, Vivtek®, Apaptek®, Fibratek®, Micronal®, MPCM, and PCMBlend, and those available from Croda under the tradename CrodaTherm®.

The encapsulated phase change material is preferably present in the working fluid at a total level from 0.5 wt % to 35 wt %, more preferably from 5 wt % to 20 wt %, even more preferably from 5 wt % to 15 wt %, and especially from 8 wt % to 12 wt %, by weight of the working fluid.

More than one encapsulated phase change material can be incorporated into the working fluid herein. For example, a first encapsulated phase change material may be included that is configured to exhibit phase change at a first (for example, lower) temperature, while a second encapsulated phase change material may be included that is configured to exhibit phase change at a second (for example, higher) temperature. In the case that more than one encapsulated phase change materials are used, the levels referred to above relate to the total level of encapsulated phase change materials present in the working fluid.

A second essential component of the working fluid is a base fluid. The base fluid is preferably a hydrocarbon-based base fluid which can be petroleum-based, bio-based, or synthetic. Preferably, the base fluid is present in the working fluid at a level of from 40.0 to 99.4 wt. %, more preferably from 60 wt % to 90 wt %, and more preferably from 70 wt % to 85 wt %, by weight of the working fluid.

A preferred base fluid for use herein is a Fischer-Tropsch derived base fluid. It has been found that the combination of a Fischer-Tropsch derived base fluid and a phase change material is particularly useful in the present invention from the viewpoint of achieving better cooling and thermal control of the heat-generating component, especially compared to using a working fluid based on a Fischer-Tropsch derived base fluid but not containing a phase change material. The latent heat of the phase change materials can absorb additional heat and thus achieve better cooling and thermal control.

Fischer-Tropsch derived base fluids are known in the art. By the term “Fischer-Tropsch derived” is meant that a base fluid is, or is derived from, a synthesis product of a Fischer-Tropsch process.

Fischer-Tropsch derived base fluids are often classified by the starting material in the Fischer-Tropsch process, i.e. ‘X-to-liquids’ or ‘XTL’, with X standing for said starting material. Biomass-to-liquid (BTL), coal to liquids (CTL), gas-to-liquid (GTL) and power-to-liquid (PTL) processes are some examples of Fischer-Tropsch processes producing base fluids. Preferably, the Fischer-Tropsch derived base fluid is a GTL (Gas-To-Liquids) base fluid.

Suitable Fischer-Tropsch derived base fluids including oils that may be conveniently used in the working fluid are those as for example disclosed in EP0776959, EP0668342, WO97021788, WO0015736, WO0014188, WO0014187, WO0014183, WO0014179, WO0008115, WO9941332, EP1029029, WO0118156 and WO0157166.

A particularly preferred Fischer-Tropsch derived base fluid for use in the working fluid herein is a Fischer-Tropsch derived base oil with a kinematic viscosity at 100° C. of at most 4 mm²/s, especially in the range of from 2 to 4 mm²/s, for example GTL 3 (having a kinematic viscosity at 100° C. of approximately 3 mm²/s).

Another particularly preferred Fischer-Tropsch derived base fluid for use in the working fluid herein is a Fischer-Tropsch derived base fluid produced from a gas oil stream, preferably a dewaxed gas oil stream, from a GTL process, wherein said fluid has a kinematic viscosity at 40° C. in the range of from 2.0 to 22 mm²/s, preferably from 2.0 to 11 mm²/s. Preferably said Fischer-Tropsch derived base fluid produced from a gas oil stream has a kinematic viscosity at 40° C. of at least 2.1 mm²/second, more preferably at least 2.2 mm²/second. Also preferably, said fluid has a kinematic viscosity at 40° C. of at most 10.0 mm²/second, more preferably at most 7.0 mm²/second, most preferably at most 6.0 mm²/second.

In one embodiment of the invention the working fluid comprises a mixture of more than one Fischer-Tropsch derived base fluids. For example, the working fluid may comprise both a Fischer-Tropsch derived base oil with a kinematic viscosity at 100° C. in the range of from 2 to 4 mm²/s and a Fischer-Tropsch derived base fluid produced from a gas oil stream.

It has been found that mixing encapsulated PCM in GTL or organic base fluid is more practical than mixing with water/glycol base fluid since many typical PCMs have a similar density to GTL or organic base fluid. By doing this, encapsulated PCMs can be made more suitable to direct cooling as opposed to indirect cooling.

Other components within the working fluid may include one or more additional base oils including mineral oils and synthetic oils. Mineral oils include liquid petroleum oils and solvent-treated or acid-treated mineral lubricating oil of the paraffinic, naphthenic, or mixed paraffinic/naphthenic type which may be further refined by hydrofinishing processes and/or dewaxing. Synthetic oils include hydrocarbon oils such as olefin oligomers (including polyalphaolefin base oils; PAOs), dibasic acid esters, polyol esters, polyalkylene glycols (PAGs), alkyl benzenes, alkyl naphthalenes and dewaxed waxy isomerates.

In one preferred embodiment, the working fluid comprises one or more additional base oils selected from alkyl benzenes, alkyl naphthalenes and mixtures thereof. If present, the one or more additional base oils selected from alkyl benzenes, alkyl naphthalenes and mixtures thereof are present in no more than 35 wt % with respect to the total weight of the working fluid. Preferably the one or more additional base oils selected from alkyl benzenes, alkyl naphthalenes and mixtures thereof are present in an amount in the range of from 1 to 30 wt % with respect to the total weight of the working fluid.

The working fluid preferably has a pour point of less than or equal to −40° C., more preferably less than or equal to −50° C., measured according to ISO 3016.

The working fluid also preferably has a flash point of at least 100° C., more preferably at least 110° C., most preferably at least 120° C., and preferably at most 240° C., according to ASTM D93.

The thermal conductivity of the working fluid at 20° C. is preferably at least 0.135 w/mK, measured according to ASTM D7896.

The specific heat capacity of the working fluid at 20° C., according to ASTM D 1269, is preferably at least 1.9 kJ/kg*K, more preferably at least 2.0 kJ/kg*K.

Preferably, the working fluid also comprises an antioxidant additive and an antistatic additive.

The antioxidant additive is suitably a hindered phenolic antioxidant additive, sterically hindered monohydric, dihydric and trihydric phenols, sterically hindered dinuclear, trinuclear and polynuclear phenols. Optionally, an additional amine antioxidant, for example an alkylated or styrenated diphenylamine, may be added to the working fluid.

The total amount of the one or more antioxidant additives present in the working fluid is preferably at least 0.1 wt %, more preferably at least 0.15 wt % and preferably at most 3.0 wt %, more preferably at most 2.0 wt % with respect to the total weight of the working fluid.

The antistatic additive for use herein is preferably selected from those containing alkyl substituted naphthalene sulfonic acids, benzotriazole and substituted benzotriazoles.

The content of the antistatic additive is preferably above 0.5 mg/kg and more preferably above 1 mg/kg with respect to the total weight of the working fluid. A practical upper limit may vary depending on the specific application of the lubricating composition. This concentration may be up to 3 wt %, preferably however in the range of from 1 mg/kg to 1 wt. % with respect to the total weight of the working fluid. However, such compounds may be advantageously used at concentrations below 1000 mg/kg and more preferably below 300 mg/kg with respect to the total weight of the working fluid.

### DETAILED DESCRIPTION OF THE DRAWINGS

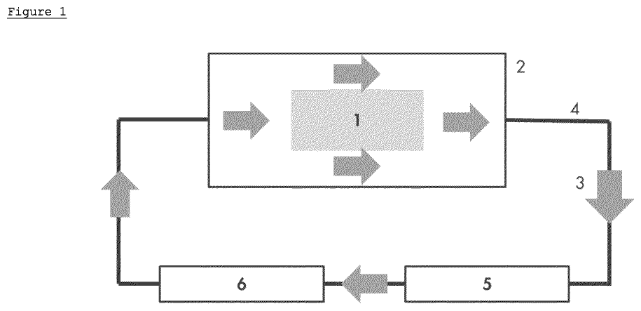

FIG. 1 shows one embodiment of a suitable liquid circuit for the thermal management system of the present invention. In FIG. 1, a heat-generating component (1) is disposed within a housing (2). Working fluid (3) flows through the interior space of the housing (1) and then through connecting pipework (4) to one or more heat exchangers (5). In this embodiment, said flow is maintained by one or more pumps (6).

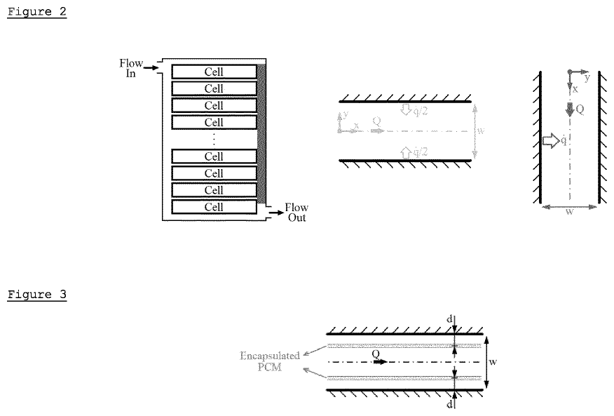

FIG. 2 is a schematic diagram of a thermal analysis of a directly cooled battery module, which is one embodiment of the system described in this invention.

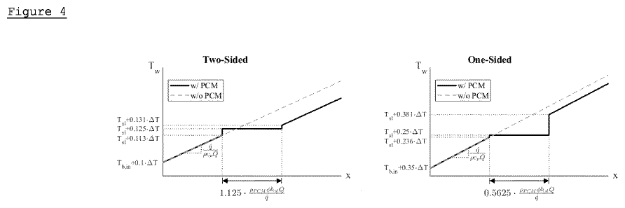

FIG. 3 is a schematic diagram of the equilibrium location of the encapsulated phase change material (PCM) in a fluid flow through the gap between battery cells or between battery cells and the module housing. It is useful to the thermal analysis illustrated in FIG. 2.

FIG. 4 shows the generic temperature distributions on battery cell surfaces, as are derived from the thermal analysis. The parameters are denoted with symbols. No parameter values have been integrated in the generic results.

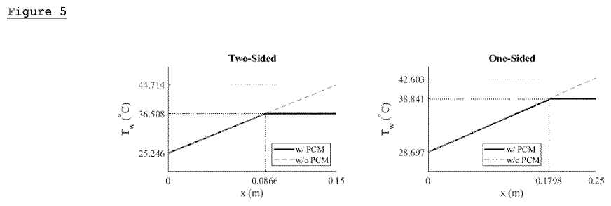

FIG. 5 shows the temperature distributions in a case study with typical materials and typical battery cells.

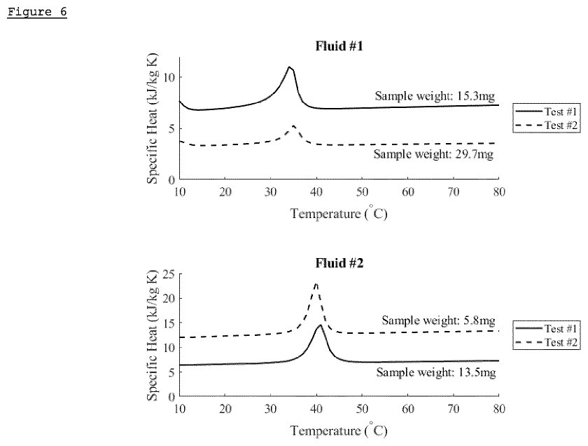

FIG. 6 is a graph showing the measurements of specific heats of two embodiments of the hereby described working fluids in the temperature range of 10° C. to 80° C.

The present invention will now further be illustrated by the following, non-limiting, examples.

### EXAMPLES

A theoretical analysis was carried out to demonstrate the benefit of using an encapsulated phase change material in a working fluid to an application of battery thermal management. A one-dimensional convection model was established to theoretically analyse the temperature distributions on the surfaces of directly cooled battery cells. By comparing the temperature distributions with a base fluid and a fluid mixed with encapsulated phase change material(s), it can be shown that the latter can give rise to better cooling and more precise thermal management.

The convective heat transfer in a battery module composed of prismatic or pouch cells was utilized to analyse the fluid flow in between the cells and on the side of the cells, as is shown in FIG. 2. The fluid flows in between the cells and on the side of the cells were analysed. In the left-hand side drawing in FIG. 2, the horizontal gap shaded with light grey is an example of fluid flow in between cells; the vertical gap shaded with dark grey is an example of fluid flow on the side of the cells. The one-dimensional convection models for the two flows are sketched in the middle and right figures, respectively.

In the analysis, and referring to FIG. 2, the cooling fluid flows through a gap with width w. x is the longitudinal coordinate along the centre axis of the gap, and y is the transverse coordinate with zero located at the centre axis. The volumetric flow rate (per unit length perpendicular to the page) of the coolant is Q, and the heat transfer rate per area into the fluid is \dot{q}. In between the cells, \dot{q} is the heat generation rate per unit side surface area of one cell, with half of it coming into the fluid from each side of the gap, as is shown by the middle drawing in FIG. 2. On the side of the cells, \dot{q} is the total heat generated by all covered cells and the heat only comes from one side of the gap.

Typically, the width of the gaps, w, is in the order of millimetres, while the dimensions of the cell side surfaces are in the order of 100 millimetres. The width of the gap, w, is typically much smaller than the width in the z direction perpendicular to the page. Hence, the variation in the z direction was ignored. Moreover, the width w is typically much smaller than the length of the gap. Thus, for simplicity, the developing region (entry region) was neglected. A one-dimensional fully developed flow in the gap was analysed.

### Flow Field

The governing equation of the flow velocity in a one-dimensional fully developed flow is:

$$0 = - \frac{dp}{dx} + μ \frac{{d}^{2} u}{{dy}^{2}} \qquad 1$$

where p is pressure, μ is the fluid viscosity, and u is the flow velocity in the x direction. The no-slip boundary condition applies on the two side walls:

$$u ( y = \pm \frac{w}{2} ) = 0 \qquad 2$$

In a fully developed flow, the pressure gradient dp/dx is independent on y. Thus, Equation 1 can be integrated in the y direction twice to obtain the velocity profile:

$$u = \frac{1}{2 μ} \frac{dp}{dx} ( {y}^{2} - \frac{{w}^{2}}{4} ) \qquad 3$$

The volumetric flow rate (per unit length perpendicular to the page) Q can be obtained by integrating Equation 3:

$$Q = - \frac{{w}^{3}}{12 μ} \frac{dp}{dx} \qquad 4$$

By plugging Equation 4 back into Equation 3, the velocity profile can be written in flow rate instead of pressure gradient:

$$u = \frac{6 Q}{{w}^{3}} ( \frac{{w}^{2}}{4} - {y}^{2} ) \qquad 5$$

The flow velocity profile does not vary with the thermal boundary conditions. That is, Equation 5 applies to both conditions in FIG. 2. Moreover, regarding the working fluids with encapsulated phase change material(s), it was assumed that the capsules are sufficiently small, that the concentration of the capsules is sufficiently small, and that the capsules are homogeneously suspended in the working fluid. With these assumptions, the bulk of the fluid was still treated as a homogeneous Newtonian fluid and Equation 5 sufficiently models the flow field. Having said this, Equation 5 is applicable to all the scenarios to be analysed in these Examples.

### Temperature Distribution

The governing equation for the temperature distribution in a one-dimensional fully developed flow is:

$$u \frac{dT}{dx} = α \frac{{d}^{2} T}{{dy}^{2}} \qquad 6$$

where T is temperature, α is the thermal diffusivity of the fluid, and u is the flow velocity in the x direction, as is described by Equation 5. While the governing equation applies to all the scenarios to be analysed, the boundary conditions vary with the thermal boundary condition and the fluid.

### Without Encapsulated PCM

For a working fluid without PCM capsules, Equation 6 is applicable all across the gap. In a fully developed flow, dT/dx does not depend on y. Integrating Equation 6 across the gap, it can be found that:

$$\frac{dT}{dx} = \frac{α}{Q} ( \frac{dT}{dy} {\vert}_{y = \frac{w}{2}} - \frac{dT}{dy} {\vert}_{y = - \frac{w}{2}} ) \qquad 7$$

From here, the thermal boundary condition will make a difference.

With Heat Transfer from Both Side Walls

This scenario applies to the gap in between cells, as is sketched in the middle drawing in FIG. 2. The heat transfer rate into the fluid on the side walls should match the heat transfer from the cells. Thus:

$$- k \frac{dT}{dx} {\vert}_{y = \frac{w}{2}} = - \frac{\dot{q}}{2} \qquad 8$$

$$- k \frac{dT}{dy} {\vert}_{y = - \frac{w}{2}} = \frac{\dot{q}}{2}$$

where k is the thermal conductivity of the fluid. Plugging Equation 8 into Equation 7, it can be obtained that:

$$\frac{dT}{dx} = \frac{\dot{q}}{ρ {c}_{p} Q} \qquad 9$$

where p is the fluid density, and cₚ is the specific heat of the fluid. Note that

$$α = \frac{k}{ρ {c}_{p}} .$$

Now, Equations 5 and 9 can be plugged into Equation 6 to obtain the governing equation for T:

$$\frac{{d}^{2} T}{{dy}^{2}} = \frac{6 \dot{q}}{{w}^{3} k} ( \frac{{w}^{2}}{4} - {y}^{2} ) \qquad 10$$

By integrating Equation 10 twice with the boundary conditions 7, the temperature distribution can be obtained:

$$T = {T}_{w} - \frac{\dot{q} w}{k} [ \frac{1}{2} {( \frac{y}{w} )}^{4} - \frac{3}{4} {( \frac{y}{w} )}^{2} + \frac{5}{32} ] \qquad 11$$

where T_{w} is the temperature on the cell surface, that is:

$${T}_{w} = T ( y = \pm \frac{w}{2} ) \qquad 12$$

T_{w} is the ultimate objective of the current analysis. It indicates the effectiveness of the thermal control to the battery cells with the given heat generation in a certain operating condition of the battery cells. In order to more easily compare the battery cell surface temperature and the fluid temperature that varies across the gap, the bulk (mean) temperature, T_{b}, of the fluid was defined:

$${T}_{b} = \frac{1}{w} {\int }_{- \frac{w}{2}}^{\frac{w}{2}} T dy \qquad 13$$

After some algebra:

$${T}_{w} = {T}_{b} + \frac{\dot{q} w}{10 k} \qquad 14$$

Up to now, it is shown that the cell surface temperature, T_{w}, increases along the flow direction with a slope described in Equation 9, and is higher than the bulk fluid temperature by an amount described in Equation 14.

With Heat Transfer from Only One Wall

This scenario applies to the gap on the side of the cells, as is sketched in the right-hand side drawing in FIG. 2. In this analysis, the other wall was assumed insulating so that all heat generated from the cells were carried away through the convection of the working fluid. That is, there was no mechanism of heat transfer through the housing of the module. With this assumption, the thermal boundary conditions are:

$$\begin{matrix}- k \frac{dT}{dy} {\vert}_{y = \frac{w}{2}} = 0 & - k \frac{dT}{dy} {\vert}_{y = - \frac{w}{2}} = \dot{q}\end{matrix} \qquad 15$$

Plugging Equation 15 into Equation 7 resulted in the same equation as Equation 9, and thus Equation 10. By integrating Equation 10 twice with the boundary conditions 15, one can get:

$$T = {T}_{w} - \frac{\dot{q} w}{k} [ \frac{1}{2} {( \frac{y}{w} )}^{4} - \frac{3}{4} {( \frac{y}{w} )}^{2} + \frac{1}{2} ( \frac{y}{w} ) + \frac{13}{32} ] \qquad 16$$

$$and$$

$${T}_{w} = T ( y = - \frac{w}{2} ) = {T}_{b} + \frac{7 \dot{q} w}{20 k} \qquad 17$$

### With Encapsulated PCM

As the working fluid flows through the gap, its temperature increases. Before the encapsulated phase change material reaches its melting point and after it has completely melted, the foregoing analysis for the fluid without encapsulated PCM still holds. However, the temperature distribution during the melting process is different. This is the focus of this section.

Studies showed that, in a fluid flow through a gap, suspended particles are not evenly distributed across the transverse [See Koh, C., Hookham, P., & Leal, L. (1994). ‘An experimental investigation of concentrated suspension flows in a rectangular channel’, Journal of Fluid Mechanics, 266, 1-32.]. They tend to move to an equilibrium position, which was reported to be between 0.4 and 0.6 times the half gap width from the central axis [see Feng, J., Hu, H., & Joseph, D. (1994), ‘Direct simulation of initial value problems for the motion of solid bodies in a Newtonian fluid. Part 2. Couette and Poiseuille flows, Journal of Fluid Mechanics, 277, 271-301. See also Schonberg, J., & Hinch, E. (1989). Inertial migration of a sphere in Poiseuille flow, Journal of Fluid Mechanics, 203, 517-524 and Di Carlo, D., Edd, J. F., Humphry, K. J., Stone, H. A., & Toner, M. (2009), Particle Segregation and Dynamics in Confined Flows. Physical Review Letters, 102, 094503]. The particle concentration peaks at the equilibrium position and attenuates away from the equilibrium position, though not zero. For simplicity, in this current analysis, it was assumed that all the PCM capsules moved to an equilibrium position, of which the distance from the side walls is d, and that the PCM capsules formed a band with negligible thickness, as is sketched in FIG. 3. This is a simple model to generally demonstrate the effect of the encapsulated phase change materials.

When the phase change material is melting, the temperature in the bands of PCM capsules is maintained at the melting point. Meanwhile, in an ideal fully developed flow, dT/dx does not vary in the y direction. As a result,

$$\frac{dT}{dx} = 0$$

everywhere and Equation 6 becomes:

$$\frac{{d}^{2} T}{{dy}^{2}} = 0 \qquad 18$$

$$and thus :$$

$$T = {C}_{1} y + {C}_{2} \qquad 19$$

where C₁ and C₂ are two constants to be determined from boundary conditions. Note that Equation 19 cannot be applied across the bands of phase change materials. The constants will change across the bands. In reality, the transition from the fourth-order temperature distribution (Equation 11 and 16) to the linear temperature distribution is gradual through a transition region. However, in this theoretical analysis, the transitional region was neglected.
With Heat Transfer from Both Side Walls

For the fluid between the wall and one of the PCM ands, say, between

$$y ∈ [ - \frac{w}{2} , - \frac{w}{2} + d ] ,$$

the boundary conditions are:

$$\begin{matrix}T {\vert}_{y = - \frac{w}{2} + d} = {T}_{sl} & - k \frac{dT}{dy} {\vert}_{y = - \frac{w}{2}} = \frac{\dot{q}}{2}\end{matrix} \qquad 20$$

where Tₛₗ is the melting point of the encapsulated phase change material. After some algebra:

$${T}_{w} = {T}_{sl} + \frac{\dot{q} d}{2 k} \qquad 21$$

The same result can be obtained with the fluid in

$$y ∈ [ \frac{w}{2} , \frac{w}{2} - d ]$$

because of symmetry. Equation 21 indicates that, when the phase change material is melting, the wall temperature is higher than the melting point of the phase change material by a certain amount. The wall temperature does not increase along the flow direction in this scenario, which is the major benefit of introducing phase change materials into the working fluid.

The application of Equation 19 to the fluid between the two PCM bands indicates that the fluid there is at a uniform temperature, Tₛₗ, given that the transition region was neglected. The uniform temperature distribution indicates that the heat generated by the battery cells is fully absorbed by the phase change material through the latent heat. Accordingly, the length of the gap segment in which the phase change material melts can be calculated.

$${l}_{sf} = \frac{{ρ}_{PCM} w ϕ {h}_{sl}}{\dot{q}} \cdot u ( y = - \frac{w}{2} + d ) \qquad 22$$

where l_{sf} is the length of the gap segment in which the phase change material melts, ρ_{PCM} is the density of the phase change material, ϕ is the volumetric concentration of the phase change material in the fluid, and hst is the latent heat of melting of the phase change material. Note that the phase change material was assumed to accumulate in the two bands. Thus, the velocity u at the location of the band should be used instead of the bulk/mean velocity.
With Heat Transfer from Only One Wall

With heat only transferred from the lower wall at

$$y = - \frac{w}{2} ,$$

the temperature distribution between the lower wall and the lower PCM band can still be described by Equation 20 and 21, except that the heat transfer rate \dot{q} needs to be doubled.

$${T}_{w} = {T}_{sl} + \frac{\dot{q} d}{k} \qquad 23$$

However, in the fluid between the upper wall and the upper PCM band, the temperature is uniform at Tₛₗ. The heat from the battery is absorbed only by the phase change material in the lower band, while the upper band has no function in absorbing heat. Thus, l_{sf} need to be halved.

$${l}_{sf} = \frac{{ρ}_{PCM} w ϕ {h}_{sl}}{2 \dot{q}} \cdot u ( y = - \frac{w}{2} + d ) \qquad 24$$

### SUMMARY OF THE ANALYSIS

In order to facilitate a quantitative evaluation, it was assumed that

$$d = \frac{w}{4} ,$$

that is, the bands of encapsulated PCM are located in the middle between the centre axis and the side walls. This is consistent with the range of the equilibrium position as was reported in literature [see Feng, J., Hu, H., & Joseph, D. (1994), “Direct simulation of initial value problems for the motion of solid bodies in a Newtonian fluid”, Part 2, Couette and Poiseuille flows, Journal of Fluid Mechanics, 277, 271-301. See also Schonberg, J., & Hinch, E. (1989), “Inertial migration of a sphere in Poiseuille flow”, Journal of Fluid Mechanics, 203, 517-524 and Di Carlo, D., Edd, J. F., Humphry, K. J., Stone, H. A., & Toner, M. (2009), “Particle Segregation and Dynamics in Confined Flows”, Physical Review Letters, 102, 094503]. Then, the variation of the wall (battery cell surface) temperature along the flow direction can be summarized in FIG. 4.

In FIG. 4,

$$Δ T = \frac{\dot{q} w}{k}$$

for simple demonstration,
T_{b,in}=T_{b}(x=0) is the inlet (bulk) fluid temperature.

Without encapsulated phase change materials in the working fluid, the wall temperature increases linearly with the longitudinal position, with a slope of \dot{q}/pcₚQ in both scenarios.

With encapsulated phase change material(s) in the fluid, there can be up to 3 segments. Before the phase change material reaches its melting point, the wall temperature rises as if there is no phase change material, with the assumption that the dilute PCM capsules have negligible effects on the bulk fluid properties. If the heat generation rate is sufficiently large, and/or if the fluid flow rate is sufficiently small, the phase change material can reach its melting point and keep the wall temperature constant in the second segment. With even more sufficient heat generation rate and/or more sufficiently small flow rate, all the encapsulated phase change material can be melted. After that, the wall temperature will again rise linearly with longitudinal position with the same slope as in the first segment, as if there is no phase change material in the fluid. As can be noted, in FIG. 4, the transitions between the three segments are not gradual. This is attributed to the assumption of fully developed flow in the analysis. In reality there should be relatively short developing regions that smoothen the transitions. As will be shown in a case study, the steps in the subtle transitions are very small in practice. Thus, neglecting the developing regions does not effectively hinder the analysis of the temperature distribution. It is also worth clarifying a misleading indication arising from the assumption of fully developed flow. Judging from FIG. 4, the constant temperature in the second segment could possibly be higher than the temperature with the base fluid without PCM at the right end of the second segment. In this case, the phase change material appears to alleviate the cooling effect. While this is possible with the idealized settings in the analysis, this is impossible in reality. In the analysis, this happens when the second segment is very short. In reality it will be even shorter than the short transition region. The transition region will smoothen the subtle temperature rise and delay the temperature rise towards the downstream. As a result, the actual temperature rise should be lower than that predicted by the analysis and the PCM will still give rise to a lower temperature compared to pure base fluid.

FIG. 4 demonstrates the benefit of introducing encapsulated phase change materials into working fluids for direct cooling. The phase change materials can defer the temperature rise in the battery and maintain the battery temperature at a constant level in a certain region. By matching the melting point of the phase change material to the optimal working temperature of the battery, the working fluid can significantly improve the efficiency and decelerate the aging in the battery.

### Case Study

In this section, some typical values of the parameters will be plugged into the analysis to demonstrate the benefit of encapsulated phase change materials in a more straightforward manner.

For the base fluid, the properties of Shell Thermal Fluid E5™ 410 (commercially available from Shell) at 40° C. was used. All properties involved in this analysis are almost constant between 20° C. to 60° C., which is the typical range of operating temperatures of battery cells.

For the phase change material, properties of eicosane were taken. Eicosane has a melting point of about 36.2° C., which is close to the optimal fast charging temperature of many battery cells.

For the parameters related to the battery, typical parameters for a module with 10 to 20 prismatic or pouch cells were taken.

All the relevant values are shown in Table 1 below.

TABLE 1

| | | Thermal | | Specific | Thermal |
|---|---|---|---|---|---|
| | | conductivity | Density | heat | diffusivity |
| | | k | ρ | c_{ρ} | α |
| Properties | Base | 0.142 | 792.0 | 2.27 | 7.90 × |
| of the | fluid | W/m K | kg/m³ | kJ/kg K | 10⁻⁸m²/s |
| working | | | | | |
| fluid | | | | | |
| | | Melting | | Latent | Volume |
| | | point | Density | heat | conc. |
| | | Tₛₗ | ρ_{PCM} | hₛₗ | ϕ |
| | Phase change | 36.2° C. | 788.6 kg/m³ | 168.32 kJ/kg | 0.1 |
| | material | | | | |

| | | | | | | | Heat |
|---|---|---|---|---|---|---|---|
| | | | | | Inlet | Flow rate | generation |
| | | Gap | Gap | | fluid | (per width) | from |
| | | width | length | | temp. | of working | battery |
| | | W | L | | T_{b, in} | fluid Q | q |
| 1-sided | Design | 1 mm | 150 mm | Operating | 25° C. | 1.5 × 10⁻⁶ m²/s | 350 W/m² |
| 2-sided | parameters | | 250 mm | conditions | | 1.5 × 10⁻⁵ m²/s | 1500 W/m² |

FIG. 5 shows the battery cell surface temperatures, as are predicted by this analysis. With both thermal boundary conditions, the encapsulated phase change material is not completely melted, though almost, giving rise to only two segments in temperature distribution. Indeed, this indicates that the flow rate used in the analysis is well designed. With the phase change material, it is desirable to (almost) fully melt the phase change material but not to give rise to a long third segment.

With the two-sided boundary condition (the middle drawing in FIG. 2), the battery cell surface temperature is kept constant in more than 40% of the cell surface. At the exit of the gap, the phase change material reduces the temperature on the cell surface by more than 8° C. compared to the base fluid. With the one-sided boundary condition (the right-hand side drawing in FIG. 2), the battery cell surface temperature is constant in almost one third of the cell surface. At the exit of the gap, the phase change material reduces the cell surface temperature by almost 4° C. compared to the base fluid.

### Discussion

The case study of the Examples clearly demonstrates that encapsulated phase change materials can defer the battery temperature rise and thus better prevent overheating. Moreover, encapsulated phase change materials can maintain a greater portion of the battery cells at an optimal working temperature, if the phase change material is properly chosen to bear a proper melting point.

### Examples 1 and 2

Two embodiments of the hereby described working fluids were blended. The formulations of the two fluids are shown in Table 2.

TABLE 2

| | |
|---|---|
| Fluid 1 | Fluid 2 |

| | |
|---|---|
| PCM core | Paraffin Wax |

| | | |
|---|---|---|
| material | | |
| Melting point | Approximately | Approximately |
| of PCM core | 32° C. | 37° C. |

| | |
|---|---|
| Shell | Melamine Resin & Modified Urea Resin |

material

| | |
|---|---|
| Base fluid | GTL 3 |
| | (A Fischer-Tropsch derived base fluid |
| | having a kinematic viscosity at 100° C. |
| | of approximately 3 mm²/s) |

| | | |
|---|---|---|
| Concentration | 10% wt | 10% wt |
| of PCM | | |
| capsule | | |

Both PCM capsules were commercially available at the time of the blending. The specific heats of the blended working fluids were measured according to the ASTM E1269 standard, or more commonly referred to as the Differential Scanning calorimeter (DSC) method. Each measurement was conducted twice. The results are shown in FIG. 6 and Table 3. The specific heats of the working fluids evidently increase near the melting point of the PCM cores. Although the repeatability of the two tests was not good for unknown reasons, the increase near the melting points were evident in both measurements. This means that the working fluids will be heated up by a less temperature rise with the same amount of absorbed heat in that range of temperature. As expected, the specific heat of Fluid 2 peaks at a higher temperature than Fluid 1, because the melting point of the PCM in Fluid 2 is higher. By properly selecting the PCM material and matching the melting point to the optimal operating temperature of the system, the system can be maintained at the optimal operating temperature for a longer time.

TABLE 3

| | Specific Heat (kJ/kg K) | |
|---|---|---|
| Temperature | Fluid 1 | Fluid 1 |

| (° C.) | Test 1 | Test 2 | Test 1 | Test 2 |
|---|---|---|---|---|
| 10 | 7.69 | 3.77 | 6.45 | 12.1 |
| 20 | 6.96 | 3.38 | 6.63 | 12.34 |
| 30 | 8.16 | 3.76 | 6.91 | 12.73 |
| 32 | 9.14 | 4.05 | 7.05 | 12.88 |
| 34 | 11.01 | 4.77 | 7.29 | 13.21 |
| 36 | 8.55 | 4.74 | 7.97 | 14.1 |
| 38 | 7.21 | 3.7 | 9.75 | 17.02 |
| 40 | 6.97 | 3.46 | 13.75 | 23.41 |
| 42 | 6.93 | 3.4 | 12.03 | 15.34 |
| 44 | 6.93 | 3.39 | 8.2 | 13.33 |
| 50 | 6.98 | 3.4 | 7.03 | 12.9 |
| 60 | 7.07 | 3.45 | 7.09 | 13.05 |
| 70 | 7.17 | 3.5 | 7.19 | 13.2 |
| 80 | 7.26 | 3.55 | 7.3 | 13.35 |

1. A thermal management system comprising:
a housing having an interior space;
at least one heat-generating component disposed within the interior space; and
a working fluid disposed within the interior space such that at least part of the heat-generating component is in direct contact with the working fluid;
wherein the working fluid comprises base fluid and at least one phase change material selected from micro-encapsulated phase change materials, nano-encapsulated phase change materials, and mixtures thereof.

2. The thermal management system of claim 1, wherein the micro- and/or nano-encapsulated phase change material comprises an outer shell and an inner core of high latent heat material encased within said outer shell.

3. The thermal management system of claim 2 wherein the inner core comprises one or more materials selected from paraffinic waxes, n-alkanes, fatty acids, fatty alcohols, C4-C14 alkyl alcohols, fatty acid esters, polyglycols, chlorinated paraffin, inorganic salts, salt hydrates, sugar alcohols, carbohydrates and polyols, and mixtures thereof.

4. The thermal management system of claim 2 wherein the outer shell comprises one or more materials selected from polymers, resins, inorganic oxides, multi-walled carbon nanotubes, nanocelluloses and mixtures thereof.

5. The thermal management system of claim 1, wherein the thermal management system comprises a heat exchanger.

6. The thermal management system of claim 5 which is constructed such that a cyclical flow of working fluid can be generated across the one or more heat-generating components, on to the heat exchanger and then back to the one or more heat-generating components.

7. The thermal management system of claim 1 wherein the base fluid is a hydrocarbon-based base fluid.

8. The thermal management system of claim 1 wherein the base fluid is a Fischer-Tropsch derived base fluid.

9. The thermal management system of claim 1, wherein the thermal management system further comprises a pump, wherein the pump is configured to move the working fluid to and from the heat exchanger.

10. The thermal management system of claim 1, wherein the heat-generating component comprises a server.

11. The thermal management system of claim 1, wherein the heat-generating component is a battery.

12. The thermal management system of claim 1, wherein the heat-generating component is one or more of a battery, an e-motor and an inverter within an electric vehicle.

13. A method of thermal management of a heat-generating component comprising the steps of directly contacting at least part of the heat-generating component with a working fluid; and transferring the heat away from the heat-generating component using the working fluid wherein the working fluid comprises base fluid and at least one encapsulated phase change material selected from micro-encapsulated phase change materials, nano-encapsulated phase change materials, and mixtures thereof.

14. The method of claim 13, wherein the heat is transferred away from the heat-generating component using the working fluid in a cyclical flow of working fluid across the heat generating components, on to a heat exchanger and then back to the heat-generating component.

15. The method of claim 13, wherein said method comprises the steps of pumping the working fluid to a heat exchanger; transferring heat from the working fluid; and returning said working fluid to the heat-generating component.

16. The method of claim 1 wherein the base fluid is a hydrocarbon-based base fluid.

17. The method of claim 1 wherein the base fluid is a Fischer-Tropsch derived base fluid.
